(19) United States
(12) Patent Application Publication
(10) Pub. No.: US 2025/0222535 A1
(43) Pub. Date: Jul. 10, 2025

(54) WIRE ARC ADDITIVE MANUFACTURING BASED MULTI-LAYER FABRICATION/REPAIR OF TI PART WITH EQUIAXED/HYBRID MICROSTRUCTURE

(71) Applicant: GOODRICH CORPORATION, Charlotte, NC (US)

(72) Inventors: Ranadip Acharya, Glastonbury, CT (US); Noel Haynes, Etobicoke (CA); Alexander Staroselsky, Avon, CT (US); Roque Panza Giosa, Oakville (CA); Sergey Mironets, Burlington (CA); Jason Bradley Allen, Waco, TX (US); Zhen Li, Hamilton (CA); André Phillion, Hamilton (CA)

(73) Assignee: GOODRICH CORPORATION, Charlotte, NC (US)

(21) Appl. No.: 18/407,240

(22) Filed: Jan. 8, 2024

(51) Int. Cl. B23K 9/095; B23K 9/04; B33Y 30/00; B33Y 50/00

(52) U.S. Cl. CPC B23K 9/0953; B23K 9/04; B33Y 30/00; B33Y 50/00

(57) ABSTRACT

A method for determining build parameters for a wire arc additive manufacture machine (WAAM) is disclosed herein. The method includes receiving, by a processor, a plurality of input parameters for a WAAM process for building a component, calculating a melt pool size for the WAAM process based at least in part on the plurality of input parameters, calculating solidification parameters for a material being used for the WAAM process, determining one or more structural transition points during WAAM process for building the component, the one or more structural transition points indicating an internal microstructure of the component, generating a build file in response to the one or more structural transition points indicating that the internal microstructure of the component meets a threshold, the build file including build parameters for use by a WAAM machine, and instructing, the WAAM machine to build the component using the build file.

### FIELD

The present disclosure generally relates additive manufacturing, and more particularly, to wire arc additive manufacturing.

### BACKGROUND

Wire arc additive manufacturing (WAAM) is an important class of directed energy deposition (DED)-based additive manufacturing process where wire feedstock is fed into a plasma, or other heat source, to melt and fuse the wire feedstock into a substrate. The process enables faster production of bulk components and the addition of fine features on bulk components. Another set of characteristics that define the behavior of parts built using WAAM is microstructural characteristics of the as-built part. The WAAM process generally produces components with a columnar microstructure. Post processing treatments have been unable to change the microstructure from columnar microstructure to equiaxed microstructure. The mechanical properties of these bulk components tend to be non-isotropic due to the large columnar structures which may result in poor fatigue properties.

### SUMMARY

Disclosed herein is a method including receiving, by a processor, a plurality of input parameters for a wire arc additive manufacturing (WAAM) process for building a component, calculating, by the processor, a melt pool size for the WAAM process based at least in part on the plurality of input parameters, calculating, by the processor, solidification parameters for a material being used for the WAAM process, determining, by the processor, one or more structural transition points during WAAM process for building the component, the one or more microstructural transition points indicating an internal microstructure of the component, generating, by the processor, a build file in response to the one or more structural transition points indicating that the internal microstructure of the component meets a threshold, the build file including build parameters for use by a WAAM machine, and instructing, by the processor, the WAAM machine to build the component using the build file.

In various embodiments, the plurality of input parameters include a voltage of the WAAM, an amperage of the WAAM, and a feed speed of a feedstock of the material. In various embodiments, the solidification parameters include a temperature gradient, a solidification velocity, and a cooling rate of the material. In various embodiments, the one or more microstructural transition points indicate a transition from a columnar structure to an equiaxed structure.

In various embodiments, the method further includes determining, by the processor, the one or more structural transition points exceed the threshold indicating a desired component internal microstructure and changing, by the processor, one or more of the plurality of input parameters in response to exceeding the threshold. In various embodiments, the method further includes calculating, by the processor, residual stress in the component based on the build file.

In various embodiments, the method further includes performing, by the processor, a phase field modeling using the build file to predict the internal microstructure of the component. In various embodiments, the method further includes receiving, by the processor, build progress information from the WAAM and modifying, by the processor, one or more build parameters in response to the build progress information. In various embodiments, the method further includes identifying, by the processor, one or more build parameters to build different internal microstructures at different locations in the component to form a hybrid disc.

Also disclosed herein is a system including a wire arc additive manufacturing (WAAM) machine, a processor operatively coupled to the WAAM machine, and a memory operatively coupled to the processor. The includes instructions stored thereon that, when executed by the processor, cause the processor to receive a plurality of input parameters for a WAAM process for building a component, calculate a melt pool size for the WAAM process based at least in part on the plurality of input parameters, calculate solidification parameters for a material being used for the WAAM process, determine one or more structural transition points during WAAM process for building the component, the one or more structural transition points indicating an internal microstructure of the component, generate a build file in response to the one or more structural transition points indicating that the internal microstructure of the component meets a threshold, the build file including build parameters for use by a WAAM machine, and instruct the WAAM machine to build the component using the build file.

In various embodiments, the plurality of input parameters include a voltage of the WAAM, an amperage of the WAAM, and a feed speed of a feedstock of the material. In various embodiments, the solidification parameters include a temperature gradient, a solidification velocity, and a cooling rate of the material. In various embodiments, the one or more structural transition points indicate a transition from a columnar structure to an equiaxed structure. In various embodiments, the instructions, when executed by the processor, further cause the processor to determine the one or more structural transition points exceed the threshold indicating a desired component internal microstructure and change one or more of the plurality of input parameters in response to exceeding the threshold. In various embodiments, the instructions, when executed by the processor, further cause the processor to calculate residual stress in the component based on the build file.

In various embodiments, the instructions, when executed by the processor, further cause the processor to perform a phase field modeling using the build file to predict the internal microstructure of the component. In various embodiments, the instructions, when executed by the processor, further cause the processor to receive build progress information from the WAAM and modify one or more build parameters in response to the build progress information. In various embodiments, the instructions, when executed by the processor, further cause the processor to identify one or more build parameters to build different internal microstructures at different locations in the component to form a hybrid disc.

Also disclosed herein is a method for determining build parameters for a wire arc additive manufacture machine (WAAM) to obtain a desired internal microstructure of a component including receiving, by a processor, a plurality of input parameters for the WAAM machine to build the component, calculating, by the processor, a melt pool size of a material used by the WAAM machine based at least in part on the plurality of input parameters, calculating, by the processor, solidification parameters for the material, determining, by the processor, one or more structural transition points within the component based on the melt pool size and the solidification parameters, iterating, by the processor, through process parameters until the desired internal microstructure of the component is achieved, generating, by the processor, a build file in achieving the desired internal microstructure of the component, and instructing, by the processor, the WAAM machine to build the component using the build file.

In various embodiments, the method further includes receiving, by the processor, build progress information from the WAAM and modifying, by the processor, one or more build parameters in response to the build progress information.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft, in accordance with various embodiments.

FIG. 2 illustrates a landing gear component that may be build using wire arc additive manufacturing, in accordance with various embodiments.

FIG. 3 illustrates a system architecture for determining the parameters to use to build a component using wire arc additive manufacturing, in accordance with various embodiments.

FIGS. 4A and 4B illustrate a flow diagram of a method for determining build parameters for a wire arc additive manufacturing process, in accordance with various embodiments.

FIG. 5 illustrates the solidification parameters as calculated for a wire arc additive manufacturing process, in accordance with various embodiments.

FIG. 6 illustrates a solidification process map plotting the position of the wire arc additive manufacturing machine with respect to thermal conditions for a build process, in accordance with various embodiments.

FIG. 7 illustrates images of a phase field prediction model, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Disclosed herein are systems and methods for determining and controlling process parameters of a wire arc additive manufacturing (WAAM) process. In various embodiments, a phase field computational model may be used to predict growth structures and predict stresses in the structures. In various embodiments, a finite element analysis may be used to calculate desired build parameters based on one or more inputs and a desired build component structure.

The systems and methods disclosed herein enable the creation of a model driven parameter control in WAAM that can be utilized to deposit alloy with hybrid microstructure for multiple layers resulting in part fabrication. Additional benefits include improved fatigue strength of WAAM parts by making it of equiaxed morphology. In various embodiments, residual stress and distortion of the build component may be reduced through the use of the physics-driven modeling of residual stress as function of scan strategy. Additionally, the morphology, or internal microstructure, of the build component may be precisely controller as a function of the determine scan strategy and build parameters. In various embodiments, the morphology includes single crystal, directional certification (e.g., columnar), and equiaxed structures.

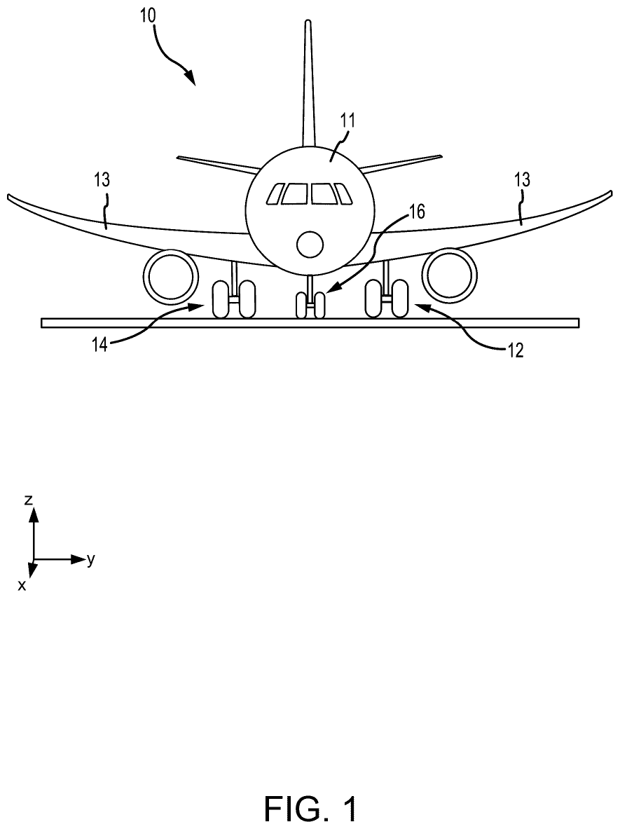

Referring now to FIG. 1, an aircraft 10 is illustrated, in accordance with various embodiments. Aircraft 10 includes a fuselage 11 and wings 13. Aircraft 10 includes landing gear such as a left landing gear assembly 12, a right landing gear assembly 14, and a nose landing gear assembly 16 (referred to herein collectively as landing gear assemblies 12, 14, 16). Landing gear assemblies 12, 14, 16 may generally support aircraft 10, when aircraft 10 is not flying, allowing aircraft 10 to taxi, take-off, and land without damage. Landing gear assemblies 12, 14, 16 may each include various shock and strut assemblies with one or more wheels attached thereto. Landing gear assemblies 12, 14, 16 may each be configured to translate between a landing gear down position, wherein the landing gear assemblies extend from wings 13 and/or fuselage 11 to support aircraft 10, and a landing gear up position, wherein the landing gear assemblies are located within wings 13 and/or fuselage 11 of aircraft 10. For example, during taxiing and take-off, and landing, landing gear assemblies 12, 14, 16 may be in the landing gear down position. After take-off, landing gear assemblies 12, 14, 16 may be translated to the landing gear up position. Prior to landing, landing gear assemblies 12, 14, 16 may be translated to the landing gear down position to support aircraft 10 during landing.

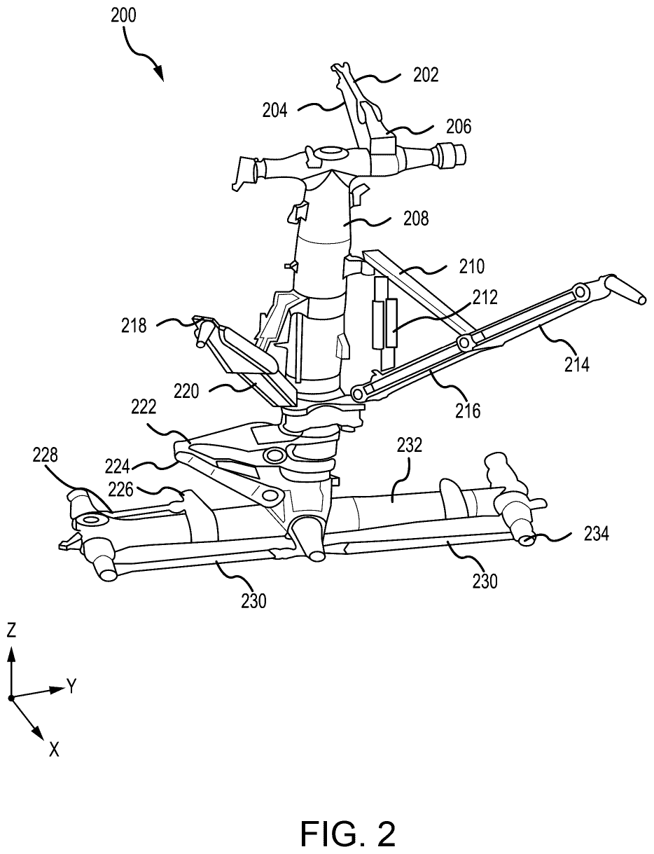

Referring now to FIG. 2, a landing gear component 200 is illustrated, in accordance with various embodiments. In various embodiments, landing gear component 200 may manufactured using steel, aluminum, titanium, and titanium alloys, among others. In various embodiments, landing gear component 200 may manufactured of a number of sub-components and assembled. In various embodiments, each sub-component may be manufactured using an additive manufacturing process. In various embodiments, the additive manufacturing process may be a wire arc additive manufacturing (WAAM) process.

Landing gear component 200 sub-components include an upper link 202, a lower link 204, a retract arm 206, a shock strut 208, lock links 210, springs 212, an upper drag strut 214, a lower drag strut 216, an upper side strut 218, a lower side strut 220, an upper torque link 222, a lower torque link 224, a steering crank 226, a reaction link 228, brake rods 230, a truck beam 232, and axles 234. Manufacturing one or more of these sub-components using the WAAM process as informed by the methods disclosed herein results in the sub-components having isotropic strength characteristics. That is, the sub-components tend to handle stresses from different directions equally. Specifically, the sub-components include columnar microstructures and equiaxed microstructures to handle stresses in the z-axis as well as in the x-axis and y-axis.

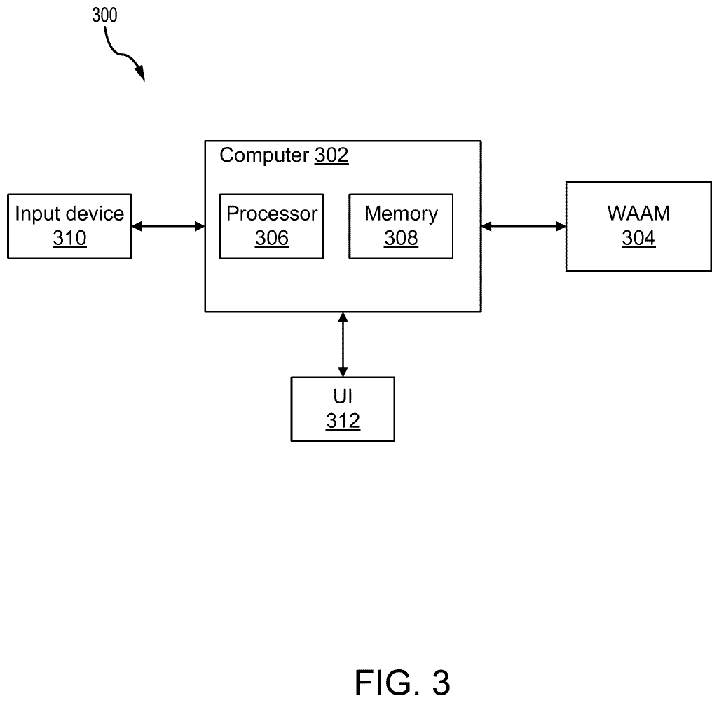

Referring now to FIG. 3, a system architecture, system 300, for determining the parameters to use for improved strength of wire arc additive manufacturing (WAAM) components is illustrated, in accordance with various embodiments. System 300 may be used for determining parameters for a WAAM build to obtain repeatable build results for each component built. The specific repeatability is related to the microstructure of the components. WAAM manufacturing tends to result in columnar microstructures with grains extending in the z-direction that have higher tensile and fatigue strength in the x and y-direction and weak in the z-direction, being orthogonal to the x- and y-direction. Alternative build structures are possible, such as equiaxed structures and alternating between columnar and equiaxed structure, by modifying the WAAM process parameters. While columnar structures tend to be longer in the z-direction than in the x and y-direction, equiaxed structures tend to have equal dimensions in the z-direction and the x- and y-direction. This results in improved strength of the build component.

System 300 includes a computer 302 and a wire arc additive manufacturing (WAAM) machine. In various embodiments, computer 302 may be a personal computer, a server, or other computing device.

Processor 306 may include one or more processors configured to implement various logical operations in response to execution of instructions, for example, instructions stored on a non-transitory, tangible, computer-readable medium. The one or more processors can be a general purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. Memory 308 may include memory to store data, executable instructions, system program instructions, and/or controller instructions to implement the control logic of processor 306.

Computer 302 is operatively coupled to an input device 310 and a user interface (UI) 312. In various embodiments, input device 310 may be a keyboard, a tablet, a mouse, or a stylus, among others. In various embodiments, UI 312 may be a monitor, a television, a liquid crystal display (LCD) screen, or an e-ink screen, among others.

Computer 302 includes a processor 306 and a memory 308 operatively coupled to processor 306. Computer 302, and more specifically, processor 306 is configured to receive inputs, run a model, and output parameters for use with WAAM 304. In various embodiments, computer 302 may receive the inputs from input device 310. In various embodiments, computer 302 may receive the inputs as a file received over a network or from a removable memory storage device. In various embodiments, the model may be a finite element analysis of the WAAM build process to determine WAAM build parameters. In various embodiments, the model may be a physics-based predictive model to determine WAAM build parameters.

In various embodiments, computer 302 outputs the determined build parameters to UI 312. In various embodiments, computer 302 communicates the determined build parameters directly to WAAM 304. In various embodiments, computer 302 may monitor the build process of WAAM 304 and modify parameters based on the progression of the build process. In various embodiments, the build parameters include voltage, amperage, and feed speed of feedstock for WAAM 304. In various embodiments, build parameters may further include initial temperature, air temperature, substrate temperature, material properties of the feedstock, thermal conductivity of the feedstock, thermal diffusivity of the feedstock, heating rate, size of build component, size of each layer, and/or build part geometry, among others.

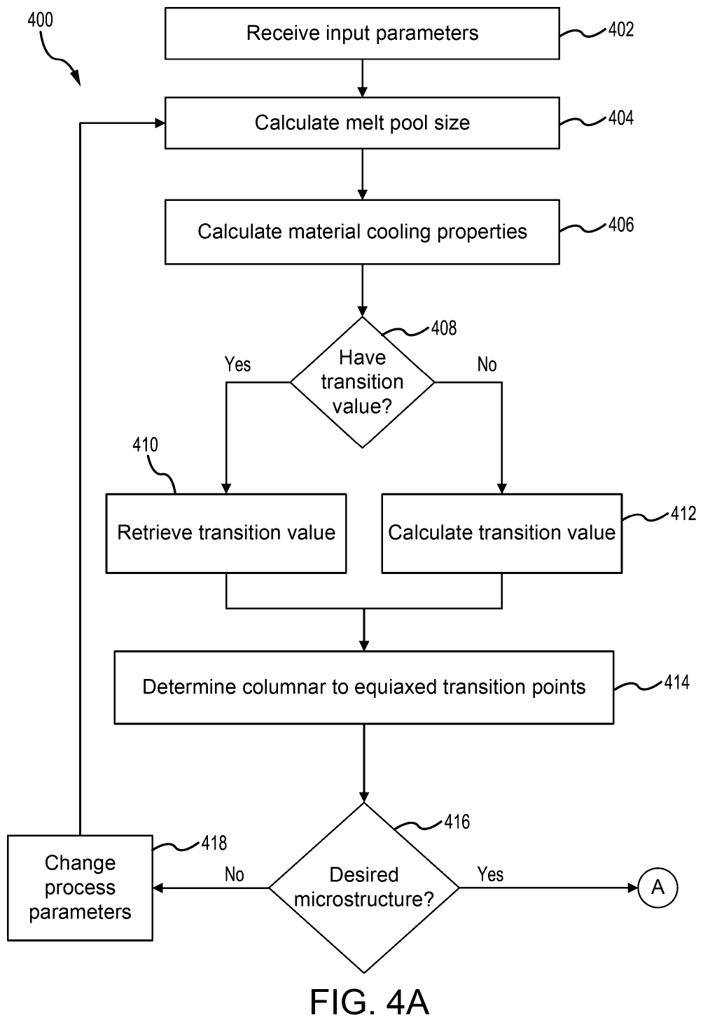

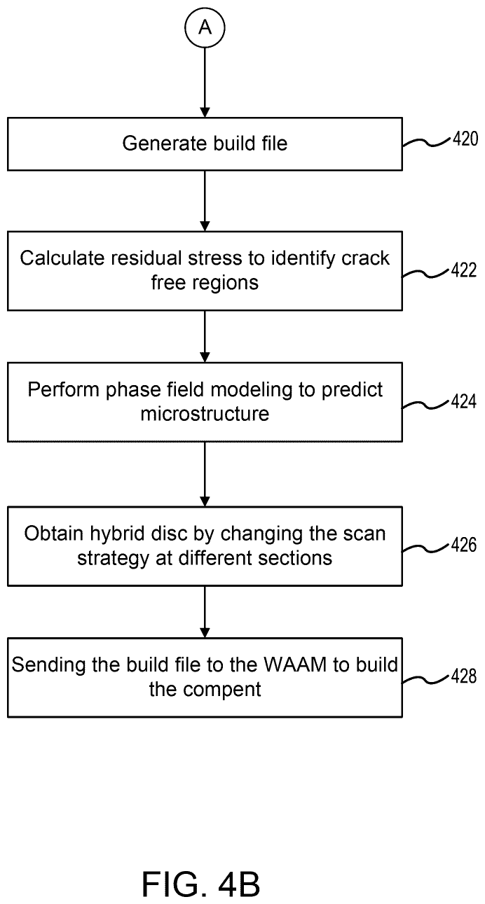

Referring now to FIGS. 4A and 4B, a block diagram of a method 400 for determining build parameters for a wire arc additive manufacturing (WAAM) process is illustrated, in accordance with various embodiments. Specifically, the build parameters allow for building specific microstructures (i.e., columnar or equiaxed) in specific locations that is repeatable across builds. In various embodiments, the steps of method 400 may be performed by computer 302, and more specifically processor 306, of system 300 in FIG. 3. In various embodiments, the build process may be performed by WAAM 304 in FIG. 3. In various embodiments, steps of method 400 may be performed in different order than described below. In various embodiments, method 400 may include more or fewer steps than discussed below.

At block 402, processor 306 receives input parameters. In various embodiments, the input parameters include at least a type of feedstock, a voltage, an amperage, and a feed speed of the feedstock for a WAAM machine. In various embodiments, the type of feedstock may be steel, aluminum, titanium, or a titanium alloy, among others. In various embodiments, input parameters may further include one or more of initial temperature, air temperature, substrate temperature, material properties of the feedstock, thermal conductivity of the feedstock, thermal diffusivity of the feedstock, heating rate, size of build component, size of each layer, and/or build part geometry, among others.

At block 404, processor 306 calculates the melt pool size and characteristics for the feedstock based at least on the receive input parameters. The melt pool size is the volume of material of the feedstock that is melting in response to being heated during the build process. The pool size and characteristics tend to determine characteristics of the material after it solidifies.

At block 406, processor 306 calculates the solidification parameters of the feedstock material. Specifically, processor 306 calculates a temperature gradient, a solidification velocity, and a cooling rate of the material. The temperature gradient, or thermal gradient G, is measured in temperature per distance (e.g., kelvin/meter). The solidification velocity Vₚ is measured in distance per time (e.g., meters/second). The cooling rate R is measured in temperature per time (e.g., kelvin/second). The WAAM machine parameters may be adjusted based at least in part on these values to control the microstructures formed in the built component based on the cooling of the material.

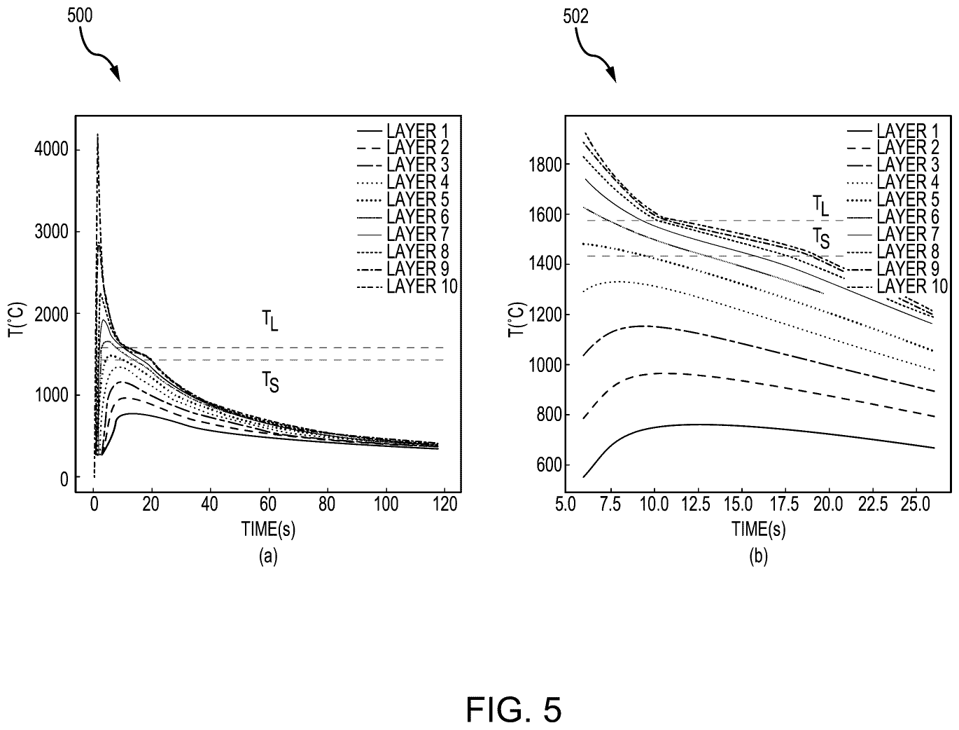

Referring momentarily to FIG. 5, a graph 500 and a graph 502 are illustrated, in accordance with various embodiments. Graph 500 illustrates the temperature measured from 0° C. to 4,000° C. of layers 1-10 of a component over time measured from 0 seconds to 120 seconds. Graph 502 is a zoomed in portion of graph 500 measuring the temperature from 600° to 1800° C. from 5 seconds to 25 seconds. Line T_{L} indicates the transition temperature at which the material liquifies and line T_{S} indicates the transition temperature at which the material solidifies. That is, the material liquifies at temperatures above line T_{L} and solidifies at temperatures below line T_{S}. The lines of graphs 500, 502 illustrate the speed at which the material in the melt pool is cooling.

At decision block 408, processor 306 determines whether a transition temperature is available for the feedstock material. If processor 306 determines that the transition temperature is available, method 400 proceeds to block 410.

At block 410, processor 306 retrieves the transition. In various embodiments, processor 306 may retrieve the transition temperature from local memory or a database.

Returning to decision block 408, if instead, processor 306 determines that the transition temperature is not available, method 400 proceeds to block 412.

At block 412, processor 306 calculates the transition temperature for the feedstock material. In various embodiments, processor 306 may use a finite element analysis model to calculate the transition temperature for the feedstock. In various embodiments, the finite element analysis may be based on a closest available material to the feedstock. In various embodiments, processor 306 may provide a warning that the transition temperature for the feedstock is not known. In various embodiments, additional experimental validation may be performed to identify the transition temperature.

At block 414, processor 306 determines the columnar to equiaxed transition points for the build component. Processor 306 analyzes the build as a function of the solidification velocity Vₚ with respect to the temperature gradient G. Based on this analysis, processor 306, is able to determine whether the component will have a columnar structure or an equiaxed structure at the different layers of the build.

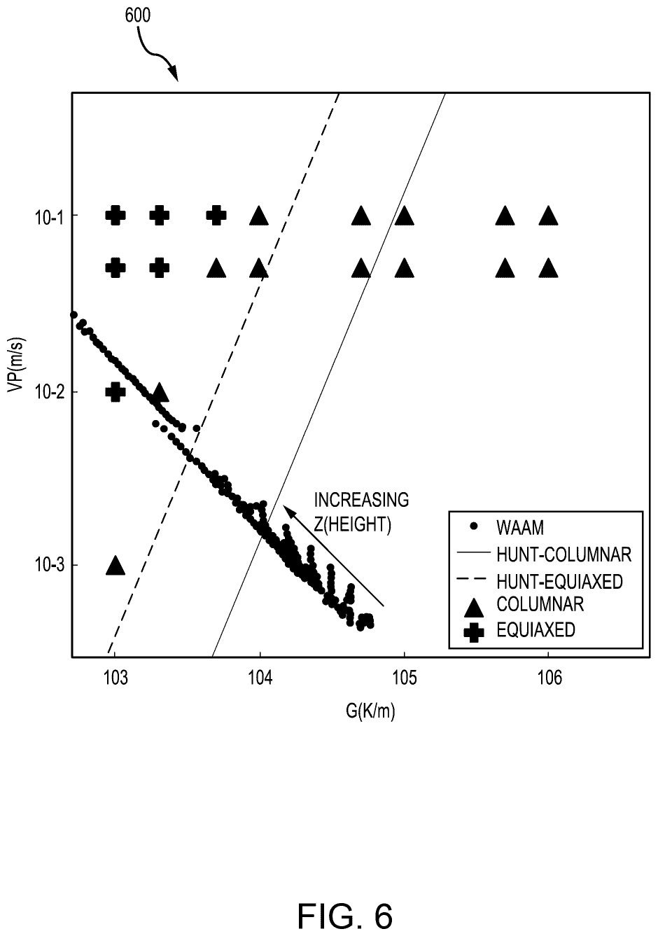

Referring momentarily to FIG. 6, a graph 600 of solidification process map plotting the position of the WAAM thermal conditions during the build process. As illustrated in graph 600, as the build progresses the build component transitions from a columnar structure to an equiaxed structure. Graph 600 is exemplary and for illustrative purposes as this was the predicted result of the given build processes. This is a visual representation that processor 306, while performing the steps of method 400, may not render.

At decision block 416, processor 306 compares the predicted microstructure to the desired microstructure. If processor 306 determines that the predicted microstructure is not within a threshold of the desired microstructure, method 400 proceeds to block 418.

At block 418, processor 306 adjusts one or more of the process parameters and returns to block 404 to repeat the previous steps. Processor 306 may iterate over the process parameters many times until the desired microstructure is achieved. In various embodiments, processor 306 may prompt a user for an input to adjust one or more of the process parameters.

Returning to decision block 416, if instead, processor 306 determines that the predicted microstructure is within the threshold of the desired microstructure, method 400 proceeds to block 420.

At block 420, processor 306 generates a build file including the calculated process parameters. In various embodiments, processor 306 may save the build file. The build file may be in any number of formats, such as for example, comma separated value (CSV), extensible markup language (XML), JavaScript object notation (JSON), or binary, among others.

At block 422, processor 306 calculates the residual stress of the built component based on the values from the build file to identify crack free regions. In various embodiments, this may include using a residual stress prediction program.

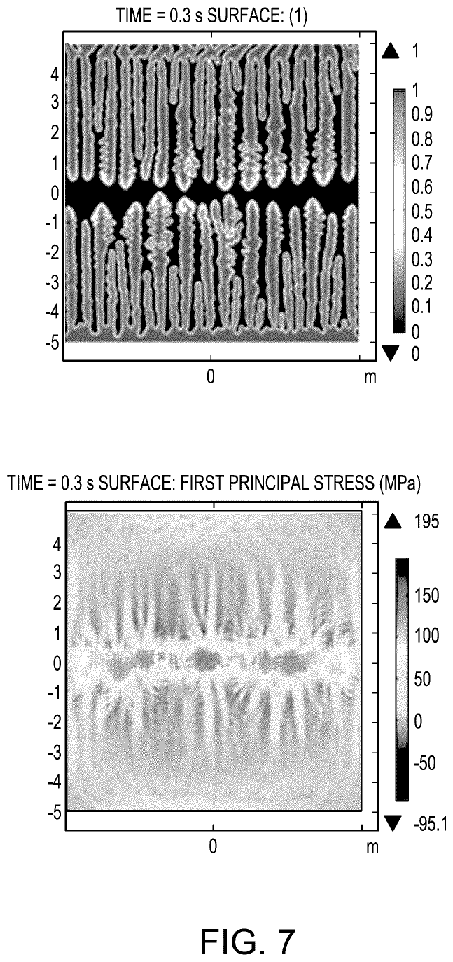

At block 424, processor 306 performs phase field modeling to predict the microstructure of the build component. Referring momentarily to FIG. 7, a first image 700 and a second image 702 representations of a phase field predication are illustrated, in accordance with various embodiments. First image 700 illustrates dendritic microstructures tend to tolerate higher stresses. Second image 702 illustrates solidification induced stresses to the built component. In various embodiments, processor 306 may determine to proceed to block 418 to change the process parameters and continue to iterate over the models in response to the analyzing the phase field model results.

At block 426, processor 306 may determine to obtain a hybrid disc by changing the scan strategy at different sections. In other words, based on the desired design, processor 306 may modify the scan, or build, strategy, or parameters, to vary the internal microstructure of the build component. That is, to alternate between a columnar structure and an equiaxed structure in different layers of the build component.

At block 428, processor 306 sends the build file to WAAM 304 to build the component. In various embodiments, processor 306 may monitor the build process. In various embodiments, processor 306 may alter the build process during the build in response to the information received from WAAM 304 during the build process.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 5% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A method, comprising:
receiving, by a processor, a plurality of input parameters for a wire arc additive manufacturing (WAAM) process for building a component;
calculating, by the processor, a melt pool size for the WAAM process based at least in part on the plurality of input parameters;
calculating, by the processor, solidification parameters for a material being used for the WAAM process;
determining, by the processor, one or more structural transition points during WAAM process for building the component, the one or more structural transition points indicating an internal microstructure of the component;
generating, by the processor, a build file in response to the one or more structural transition points indicating that the internal microstructure of the component meets a threshold, the build file including build parameters for use by a WAAM machine; and
instructing, by the processor, the WAAM machine to build the component using the build file.

2. The method of claim 1, wherein the plurality of input parameters include a voltage of the WAAM, an amperage of the WAAM, and a feed speed of a feedstock of the material.

3. The method of claim 1, wherein the cooling properties include a temperature gradient, a solidification velocity, and a cooling rate of the material.

4. The method of claim 1, wherein the one or more structural transition points indicate a transition from a columnar structure to an equiaxed structure.

5. The method of claim 1, further comprising:
determining, by the processor, the one or more structural transition points exceed the threshold indicating a desired component internal microstructure; and
changing, by the processor, one or more of the plurality of input parameters in response to exceeding the threshold.

6. The method of claim 1, further comprising:
calculating, by the processor, residual stress in the component based on the build file.

7. The method of claim 1, further comprising:
performing, by the processor, a phase field modeling using the build file to predict the internal microstructure of the component.

8. The method of claim 1, further comprising:
receiving, by the processor, build progress information from the WAAM; and
modifying, by the processor, one or more build parameters in response to the build progress information.

9. The method of claim 1, further comprising:
identifying, by the processor, one or more build parameters to build different internal microstructures at different locations in the component to form a hybrid disc.

10. A system, comprising:
a wire arc additive manufacturing (WAAM) machine;
a processor operatively coupled to the WAAM machine; and
a memory operatively coupled to the processor, the memory comprising instructions stored thereon that, when executed by the processor, cause the processor to:
receive a plurality of input parameters for a WAAM process for building a component;
calculate a melt pool size for the WAAM process based at least in part on the plurality of input parameters;
calculate solidification parameters for a material being used for the WAAM process;
determine one or more structural transition points during WAAM process for building the component, the one or more structural transition points indicating an internal microstructure of the component;
generate a build file in response to the one or more structural transition points indicating that the internal microstructure of the component meets a threshold, the build file including build parameters for use by a WAAM machine; and
instruct the WAAM machine to build the component using the build file.

11. The system of claim 10, wherein the plurality of input parameters include a voltage of the WAAM, an amperage of the WAAM, and a feed speed of a feedstock of the material.

12. The system of claim 10, wherein the solidification parameters include a temperature gradient, a solidification velocity, and a cooling rate of the material.

13. The system of claim 10, wherein the one or more structural transition points indicate a transition from a columnar structure to an equiaxed structure.

14. The system of claim 10, wherein the instructions, when executed by the processor, further cause the processor to:
determine the one or more structural transition points exceed the threshold indicating a desired component internal microstructure; and
change one or more of the plurality of input parameters in response to exceeding the threshold.

15. The system of claim 10, wherein the instructions, when executed by the processor, further cause the processor to:
calculate residual stress in the component based on the build file.

16. The system of claim 10, wherein the instructions, when executed by the processor, further cause the processor to:
perform a phase field modeling using the build file to predict the internal microstructure of the component.

17. The system of claim 10, wherein the instructions, when executed by the processor, further cause the processor to:
receive build progress information from the WAAM; and
modify one or more build parameters in response to the build progress information.

18. The system of claim 10, wherein the instructions, when executed by the processor, further cause the processor to:
identify one or more build parameters to build different internal microstructures at different locations in the component to form a hybrid disc.

19. A method for determining build parameters for a wire arc additive manufacture machine (WAAM) to obtain a desired internal microstructure of a component, comprising:
receiving, by a processor, a plurality of input parameters for the WAAM machine to build the component;
calculating, by the processor, a melt pool size of a material used by the WAAM machine based at least in part on the plurality of input parameters;
calculating, by the processor, solidification parameters for the material;
determining, by the processor, one or more structural transition points within the component based on the melt pool size and the solidification parameters;
iterating, by the processor, through process parameters until the desired internal microstructure of the component is achieved;
generating, by the processor, a build file in achieving the desired internal microstructure of the component; and
instructing, by the processor, the WAAM machine to build the component using the build file.

20. The method of claim 19, further comprising:
receiving, by the processor, build progress information from the WAAM; and
modifying, by the processor, one or more build parameters in response to the build progress information.
